(19) United States
(12) Patent Application Publication
(10) Pub. No.: US 2013/0239544 A1
(43) Pub. Date: Sep. 19, 2013

(54) Distributed pressurization system

(71) Applicants: David B. Sisk, Brownsboro, AL (US); John M. Cramer, Cameron Park, CA (US)

(72) Inventors: David B. Sisk, Brownsboro, AL (US); John M. Cramer, Cameron Park, CA (US)

(21) Appl. No.: 13/815,002

(22) Filed: Jan. 23, 2013

Related U.S. Application Data
(60) Provisional application No. 61/632,958, filed on Feb. 2, 2012.

(51) Int. Cl. F02K 9/42

(52) U.S. Cl. CPC F02K 9/42
USPC 60/204

(57) ABSTRACT

The present invention comprises a distributed system for providing warm, high pressure gas that is lighter weight, lower cost, and more reliable than comparable currant art pressurization systems. The invention employs Tridyne or another non-explosive but combustible pressurant mix flowing through a plurality of catalytic devices to provide heated pressurant to both the needed rocket system applications as well as to the plurality of pressurant storage bottles, thereby decreasing the mass of the unused pressurant at the end of mission.

### CROSS-REFERENCE TO RELATED PATENT APPLICATION & CLAIM FOR PRIORITY

The Present Non-Provisional Patent Application is related to Pending Provisional Patent Application U.S. Ser. No. 61/632,958, filed on 2 Feb. 2012. The Inventors and the Applicant hereby claim the benefit of priority for all subject matter disclosed in U.S. Ser. No. 61/632,958.

### FEDERALLY SPONSORED RESEARCH OR DEVELOPMENT

The Applicants developed some of the Inventions described in the Present Non-Provisional Patent Application under a contract with NASA Marshall Space Flight Center, Contract No. NNM09AA33C.

### FIELD OF THE INVENTION

The present invention pertains to a method for providing pressurization for rockets. More particularly, one embodiment of the present invention provides a pressurization system for rocket propellant tanks and other rocket pressure uses, such as engine or compartment purging or pneumatic controls.

### BACKGROUND OF THE INVENTION

Some conventional propellant pressurization systems for pressure fed rockets use a tank or “bottle” storing high-pressure, non-reactive gas, typically helium or nitrogen, and introduce it into the propellant tanks at a regulated pressure. This conventional system is often referred to as a cold blow down system. With a cold blow down pressurization system, the pressurant remaining in the storage bottle cools significantly due to adiabatic expansion, resulting in a large quantity of unusable, low pressure pressurant remaining in the bottle at the end of the mission. While simple and reliable, cold blow down pressurization systems have a number of disadvantages. They require a very large mass of pressurant, heavy storage bottles, are not very effective at maintaining a high pressure to the propellant tanks throughout the flight, and are penalized by carrying excessive residual, unusable, pressurant weight remaining in the pressurant bottles at the end of the mission.

The development of an improved pressurization system that overcome these problems, and that provide an improved pressurization system, would constitute a technological advance, and would satisfy long-felt needs in the aerospace industry.

### SUMMARY OF THE INVENTION

The present invention comprises a distributed system for providing warm, high pressure gas that is lighter weight, lower cost, and more reliable than comparable currant art pressurization systems. The invention employs Tridyne or another non-explosive but combustible pressurant mix flowing through a plurality of catalytic devices to provide heated pressurant to both the needed rocket system applications as well as to the plurality of pressurant storage bottles, thereby decreasing the mass of the unused pressurant at the end of mission. The main application of this pressurization system method is for space launch vehicles but it could also be employed in other rockets, missiles, spacecraft, lunar or planetary explorers, or other applications requiring compact storage and release of a gas.

In one embodiment, the first step of the invention is performed during ground operations preparing for a flight. Cold, high pressure Tridyne or another catalytic heatable pressurant mixture is pumped from an external ground system into the rocket through the high pressure inlet. The pressurant then continues along feedlines into the plurality of composite pressurant storage bottles, located within the rocket's body and external to the propellant tanks, through entrance ports. The pressurant is naturally heated by the bottle filling process as it is compressed. After the bottles are filled, a valve is opened at the exit ports of each bottle and the pressurant flows through a high pressure outlet and back out of the rocket to a conventional, cryogenic, ground support system heat exchanger. The heat exchanger cools down the high pressure Tridyne, and the pressurant is then pumped back into the rocket through the high pressure inlet. The cooled pressurant flows through the feedlines and back into the bottles. In this fashion the Tridyne is recirculated a number of times, cooling the pressurant to very low, typically cryogenic, temperatures so that the pressurant's density is greatly increased compared to that of the initial ambient pressurant bottle temperatures. Cooling the pressurant prior to flight allows the pressurant bottles to be smaller and hence lighter weight for the same mass of pressurant than without cooling.

The second step of the invention occurs just prior to and during flight. The stored Tridyne pressurant travels from a plurality of pressurant storage bottles through feedlines through catalytic devices to produce a heated, higher pressure, pressurant which then flows into the propellant tanks and other rocket pressurant applications as needed, such as pneumatic control lines or purges. The heated and expanded pressurant is eventually also directed back into the pressurant bottles by means of a manifold, thereby decreasing the final leftover, unused pressurant in the tanks at the end of the mission.

The present invention has a number of novel features. Rather than an intricate heating system built into the pressurant bottles that requires complex, expensive, one-of-a-kind pressurant bottles, the present invention heats the pressurant outside of the pressurant storage bottles, allowing for use of very low cost, non-aerospace COTS bottles and other COTS hardware to be employed, decreasing cost and increasing reliability and sustainability. The present invention provides the means to recirculate the pressurant during pre-flight ground operations and chill it to very low or cryogenic temperatures before liftoff, enabling greater pressurant weight to be stored in smaller volume, and lower weight bottles. The present invention heats pressurant that is inserted not only into the propellant tanks but also back into the pressurant storage bottles, thereby increasing the effectiveness of the pressurization system. The present invention results in a distributed system in that it employs a number of smaller components (pressurant storage bottles, control valves, catalytic reactors, mass flow regulators, etc.) rather than just a single or a few larger equivalent components as typically used in prior art, centralized pressurization systems. As a result, the present invention has higher levels of redundancy and is more reliable than prior art systems. Even with the failure of multiple valves, for example, the present invention can still provide the required levels of pressurant to the propellant tanks and other subsystems.

An appreciation of the other aims and objectives of the present invention, and a more complete and comprehensive understanding of this invention, may be obtained by studying the following description of preferred and alternative embodiments, and by referring to the accompanying drawings.

### A DETAILED DESCRIPTION OF PREFERRED & ALTERNATIVE EMBODIMENTS

### I. Overview of the Invention

One embodiment of the present invention comprises a method for providing warm, high pressure gas for pressurizing launch vehicle or missile propellant tanks that is lighter weight, lower cost, and more reliable than comparable prior art pressurization systems. One embodiment of the invention employs Tridyne or another pressurant mix flowing through a plurality of catalytic reactors to provide heated pressurant to both the needed rocket system applications as well as to a plurality of pressurant storage bottles, thereby decreasing the mass of the unused pressurant at the end of mission.

### II. Preferred & Alternative Embodiments of the Invention

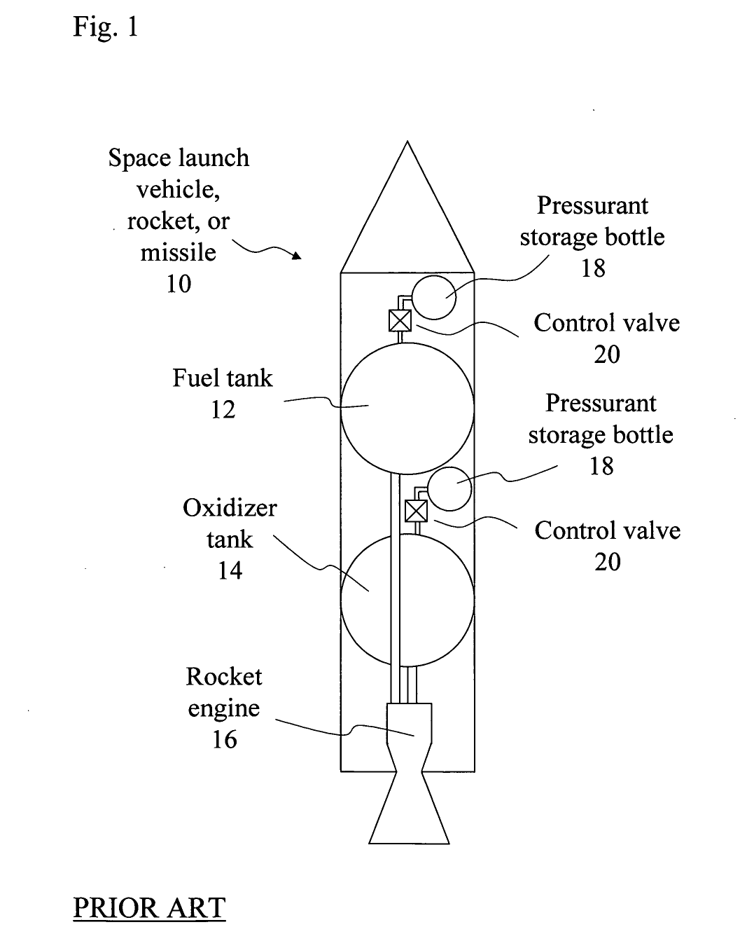

FIG. 1 illustrates a simple, prior art, blow down pressurization system for a space launch vehicle, rocket, or missile 10. FIG. 1 depicts a cut-away view, showing a fuel tank 12, an oxidizer tank 14, a rocket engine 16, and pressurant storage bottles 18 that provide pressurant to the propellant tanks through control valves 20. Pressurant forces the fuel and oxidizer to flow from their respective tanks and enter the rocket engine where the propellants are ignited and thrust is generated. Among numerous prior art pressurization system design options not shown here could be electric or catalytic heaters built into the pressurant bottles or situated exterior to the pressurant bottles between the bottles and the control valves to heat the pressurant flowing into the propellant tanks 12 and 14. Also not shown is the common use of pressurant for purging the rocket engine prior to ignition.

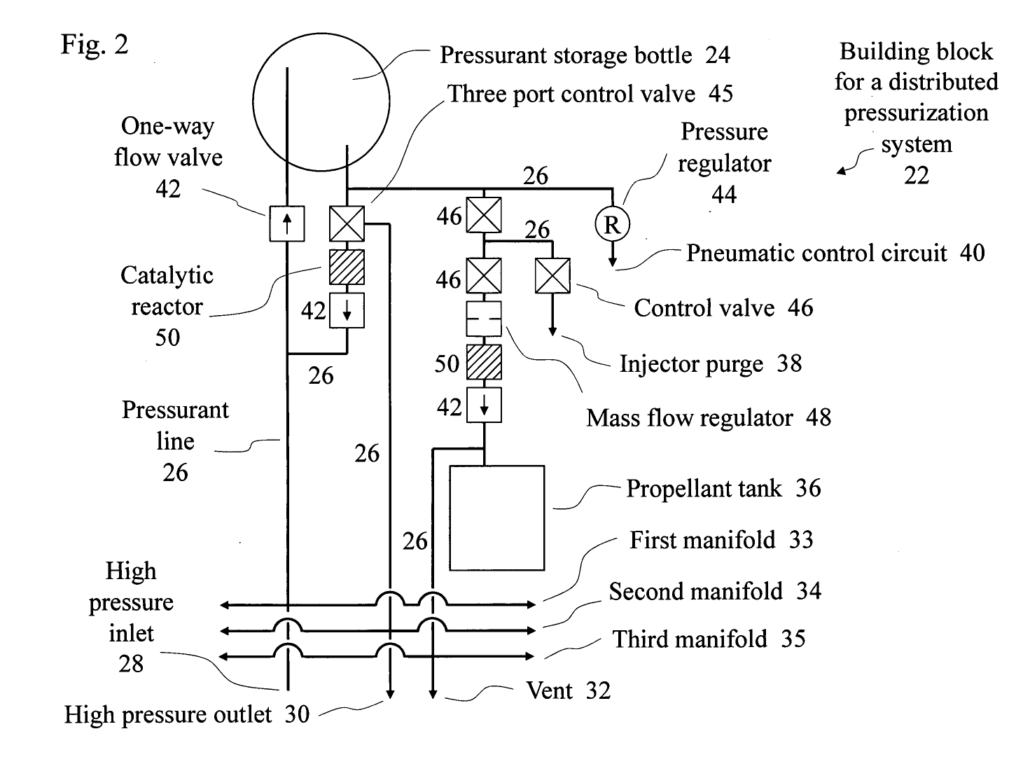

FIG. 2 is a schematic representation of a single building block for a distributed pressurization system 22, in accordance with an embodiment of the present invention. Pressurant is stored in the pressurant storage bottle 24. Pressurant lines 26 connect said pressurant storage bottle 24 to a plurality of one-way flow valves 42, control valves 45 and 46, and catalytic reactors 50, with the system designed to provide pressurant to the propellant tank 36, rocket engine injector purge 38, and to a pneumatic control circuit 40 through a pressure regulator 44. A mass flow regulator 48 is employed to provide the required mass flow rate of pressurant to the propellant tank 36. The pressurant lines 26 of this single building block for a distributed pressurization system 22 are connected to a plurality of manifolds 33, 34, and 35, and to a high pressure inlet 28, a high pressure outlet 30, and a vent 32.

Although a single pressurant storage bottle is shown in this figure, in many applications multiple pressurant storage bottles 24 may be employed in parallel. This could be done to either achieve more optimal placement of the pressurant storage bottles 24, respond to rocket design volume constraints, enable use of larger numbers of smaller, low cost, COTS bottles, a combination of these reasons, or for other purposes. Also not shown are control valves for the high pressure inlet 28, high pressure outlet 30, and vent 32.

While the primary goal of the majority of rocket pressurization systems is to provide pressurant to the propellant tanks, in some applications there are secondary needs for pressurant. The system illustrated in FIG. 2, for example, also delivers pressurant to two secondary recipients, a pneumatic control circuit 40 used for some rocket subsystems and an injector purge 38 that is used to purge the rocket engine injector before ignition. Persons possessing ordinary skill in the art to which this invention pertains will appreciate that some applications of the present invention will have no need for these secondary pressurant recipients, while other applications may require these or additional different pressurant recipients not shown here.

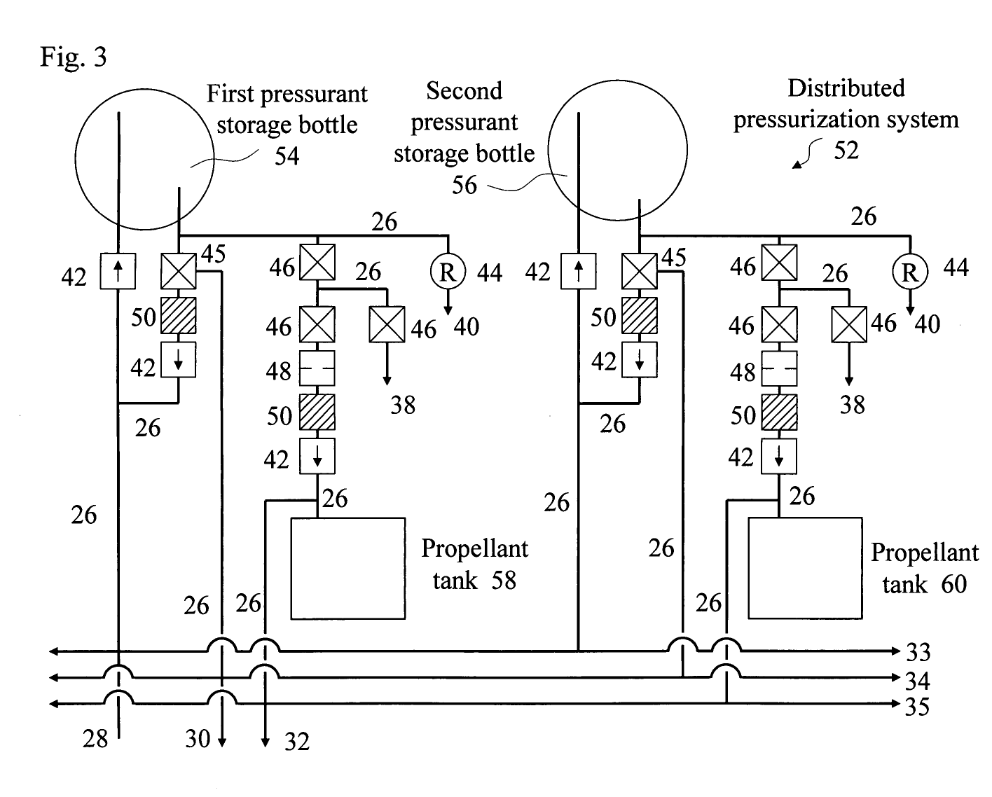

FIG. 3 is a schematic representation of a distributed pressurization system 52 for providing warm, high pressure gas for pressurizing launch vehicle or missile propellant tanks, 58 and 60, in accordance with an embodiment of the present invention. This system may employ a plurality of the building blocks 22 depicted in FIG. 2; for simplicity, only two of these building blocks are illustrated here.

Many rockets employ two propellant tanks, one for oxidizer and the other for fuel. The distributed pressurization system 52 may be employed to service both types of propellant tanks at the same time or separate distributed pressurization systems 52 could be used for each propellant type.

It will be appreciated by those skilled in the art that the present invention may be successfully applied to the case of segmented or otherwise mass producible launch systems, such as those disclosed by Sisk, U.S. Pat. No. 6,036,144. In this particular application, a large number of the single building blocks 22 would be employed. Further, separate distributed pressurization systems 52 may be dedicated to each of the propellants used, and for any additional pressurant applications as needed such as for pneumatic control lines or engine injector purges.

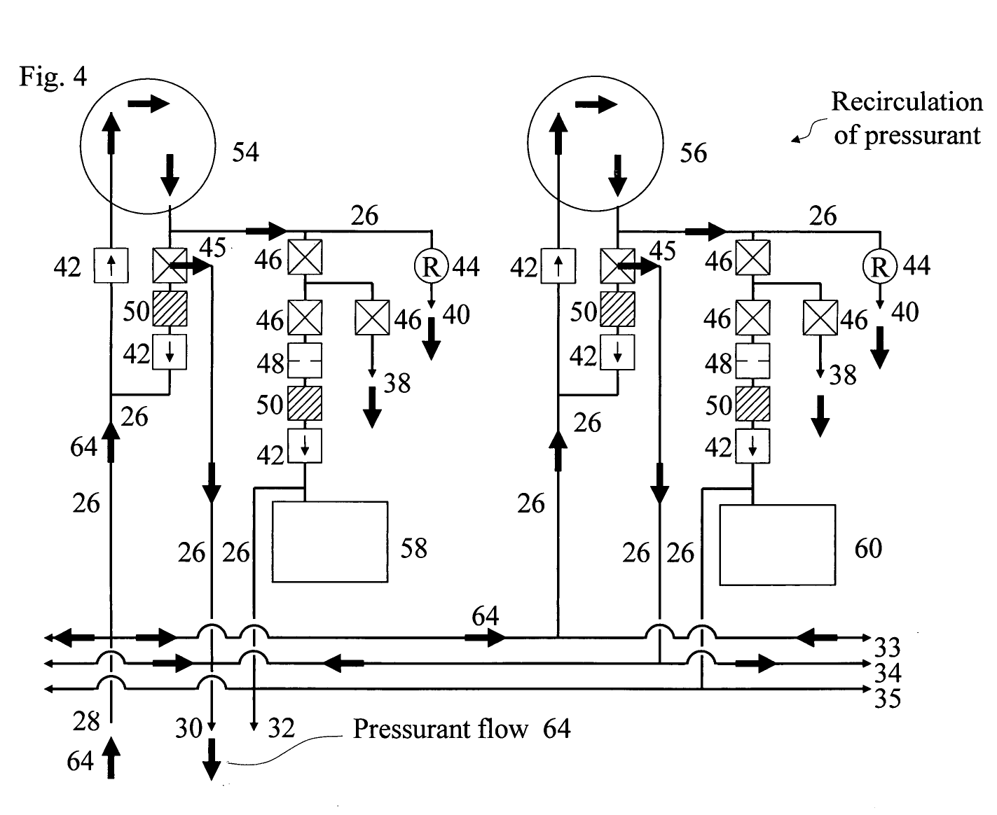

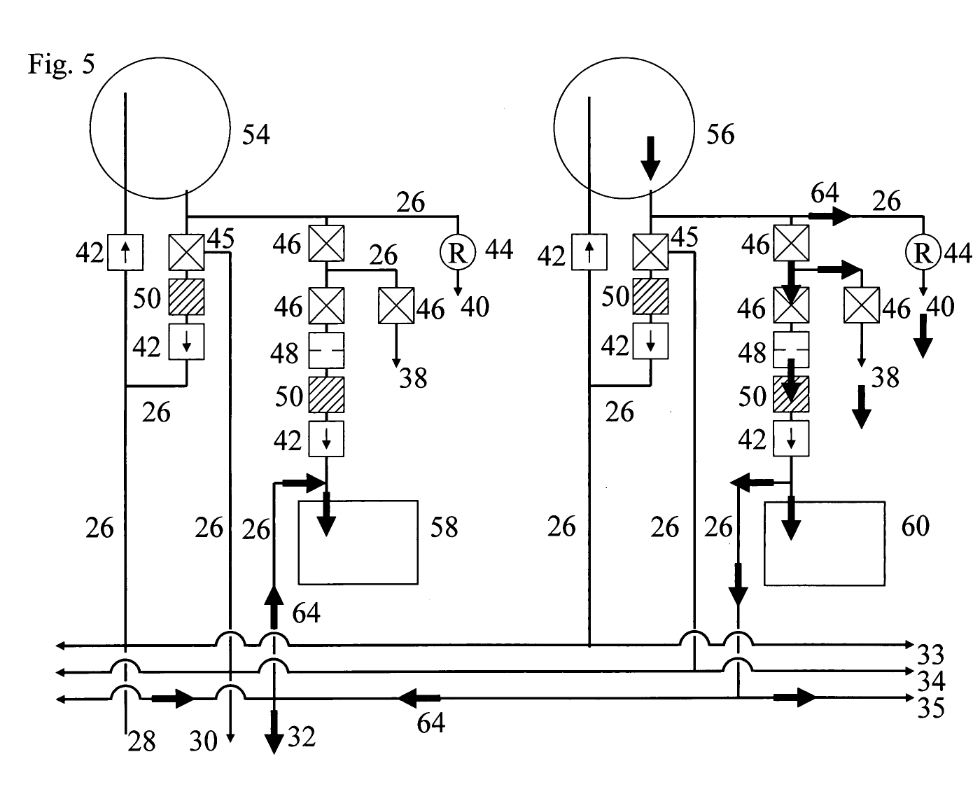

FIGS. 4, 5 & 6 illustrate various operational facets of the distributed pressurization system 52, in accordance with an embodiment of the present invention.

FIG. 4 presents a schematic of an embodiment of the present invention's recirculation of pressurant through all of the pressurant bottles while on the launch pad in order to chill the pressurant to increase its density and hence more efficiently utilize the volume of the pressurant storage bottles 54 and 56. Pressurant flow 64 enters the system from a high pressure inlet 28 that is interfaced with an external ground system source of pressurant. The pressurant travels through pressurant lines 26 that connect to a first manifold 33. Pressurant travels through the manifold and up through pressurant lines 26, through a one-way flow valve 42, and into the pressurant storage bottles 54 and 56. The pressurant continues out of the pressurant storage bottles and branches between two separate pressurant lines 26.

In the first branch from the pressurant storage bottles, the pressurant flow 64 travels through a three port control valve 45, through a pressurant line 26, and through a second manifold 34, and eventually exits the pressurization system 52 through the high pressure outlet 30. In this situation, the control valves 45 and 46 do not allow the pressurant to flow through the catalytic reactors 50.

In the second branch from the pressurant storage bottles, the pressurant flow 64 travels through a pressurant line 26 that branches again, with a portion of the pressurant traveling through two control valves 46 to exit the pressurization system 52 into a rocket engine injector purge 38 via the first sub-branch, and with the pressurant traveling through a pressure regulator 44 to exit the distributed pressurization system 52 into a pneumatic control circuit 40 via the second sub-branch.

The pressurant leaving the pressurization system 52 through the high pressure outlet 30 is chilled by conventional ground cooling systems (not shown) and pumped back into the pressurization system 52 through the high pressure inlet 28. In this fashion recirculation of the pressurant through the pressurant storage bottles 54 and 56 occurs, serving to chill the pressurant in the storage bottles and increase the pressurant's density, hence increasing the mass of pressurant that can be contained in the pressurant storage bottles. This recirculation takes place, as needed, while the rocket is on the launch pad. At some time before launch the recirculation is ceased and the high pressure inlet 28 and high pressure outlet 30 ports are closed and sealed for the flight. Some applications of this pressurization system 52, such as missiles, might not use this option.

FIG. 5 is a schematic of an embodiment of the present invention showing how warm pressurant is provided to the propellant tanks 58 and 60, injector purges 38, and pneumatic control circuits 40 by the pressurant storage bottle 56. In this situation, pressurant flow 64 exits the pressurant storage bottle 56, through a pressurant line 26. The three port control valve 45, adjacent to the pressurant storage bottle 56, is closed such that pressurant can neither flow to the second manifold 34 nor to the nearby catalytic reactor 50. The entire pressurant flow 64 hence travels through a second line branch from the pressurant storage bottle, with some of the pressurant traveling through a pressure regulator 44 to exit the pressurization system 52 into a pneumatic control circuit 40, and the remainder traveling through a control valve 46 whereupon the pressurant line 26 splits again into two sub-branches. Some of the pressurant flow 64 passes through a second control valve 46 (open only when needed) to exit the pressurization system 52 into a rocket engine injector purge 38, while the remainder of the pressurant flow 64 sequentially passes through another control valve 46, a mass flow regulator 48, a catalytic reactor 50, and a one way flow valve 42 before entering into the propellant tank 60. The combustible elements in the pressurant react as it passes through the catalytic reactor 50, serving to considerably warm the pressurant. Excess pressurant flows out of the propellant tank 60 and into the third manifold 35, whereupon it travels through the manifold and up pressurant lines 26 into the propellant tank 58. In this fashion, warm pressurant is provided to all of the propellant tanks 58 and 60 as well as the injector purges 38 and pneumatic control circuits 40 in the vicinity of the pressurant storage bottle 56.

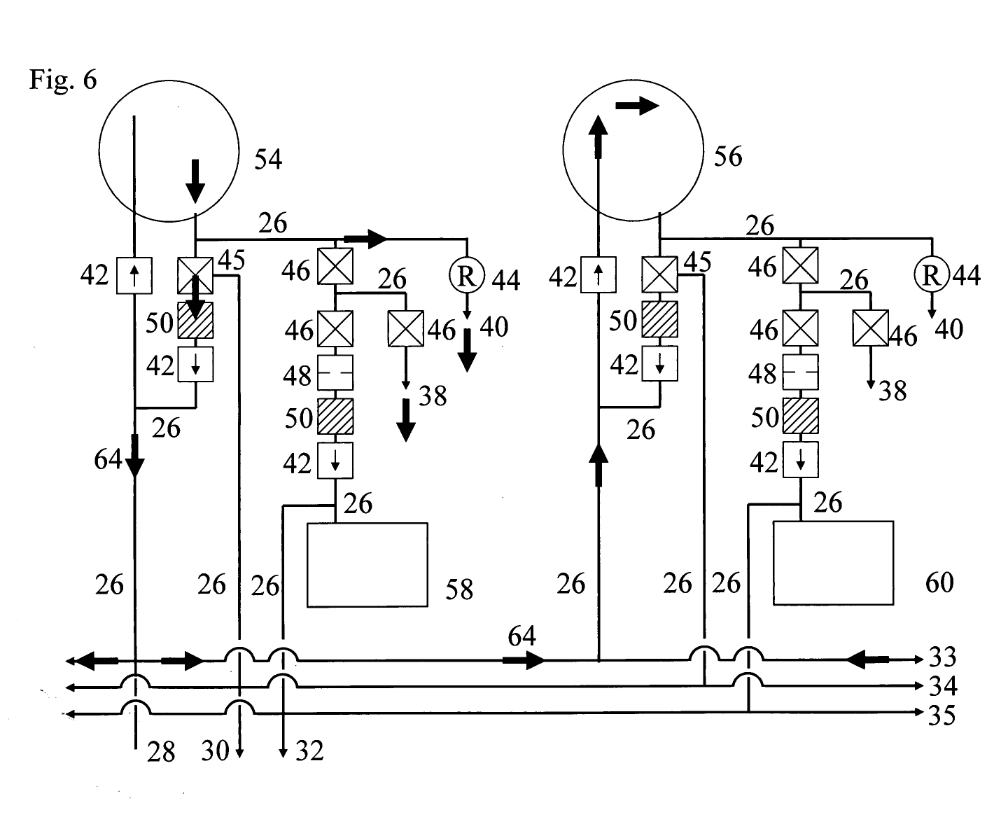

FIG. 6 presents a schematic of an embodiment of the present invention illustrating how warm pressurant is provided to the second pressurant storage bottle 56 and to the remainder of injector purges and pneumatic control circuits located near the first pressurant storage bottle 54. This occurs concurrently with the flows illustrated in FIG. 5. Pressurant flow 64 exits the first pressurant storage bottle 54, through a pressurant line 26. The three port control valve 45 adjacent to the first pressurant storage bottle 54 is closed such that pressurant can not flow to the second manifold 34 but open such that the pressurant passes through the nearby catalytic reactor 50, a one way valve 42, into the first manifold 33, and eventually into the second pressurant storage bottle 56. At the same time a portion of the pressurant flow 64 travels through a second line branch from the first pressurant storage bottle 54 with some of the pressurant traveling through a pressure regulator 44 to exit the pressurization system 52 into a pneumatic control circuit 40, and the remainder traveling through another control valve 46 (open only when needed) to exit the pressurization system 52 into a rocket engine injector purge 38.

Some applications of this pressurization system 52 will not need pressurant for rocket engine injector purge 38 or pneumatic control circuit 40 and thus these aspects of the pressurization system would not be realized.

As discussed above and as shown in FIGS. 5 and 6, the first pressurant bottle 54 provides warm pressurant to the second pressurant storage bottle 56, while the second pressurant storage bottle 56 provides warm pressurant to the propellant tanks 58 and 60. A critical facet of the present invention is that at some point during flight, the pressurant control system has the ability to reverse the functions of the pressurant storage bottles by changing the settings on the three port control valves 45 adjacent to the pressurant storage bottles 54 and 56, thereby causing the first pressurant storage bottle 54 to provide warm pressurant to the propellant tanks 58 and 60 and the second pressurant storage bottle 56 to provide warm pressurant to the first pressurant storage bottle 54. This ensures both pressure bottles receive warmed pressurant during the mission, thereby increasing overall system efficiency.

One embodiment of the invention employs commonly available, low cost, non-aerospace COTS components to decrease cost, increase reliability, and enhance sustainability. These COTS components may include composite tanks for pressurant storage bottles 54 and 56, valves 42, 45, 46, and 74, pressurant lines 26, mass flow regulators 48, catalytic reactors 50, pressure regulators 44, solenoids and other control hardware and software, and other parts.

Another embodiment of the invention is to use heaters either inside or near the catalytic reactors 50, either to heat the incoming pressurant flow or to heat the catalyst bed inside the catalytic reactors, which serves to increase the effectiveness of the catalytic reactions.

Another embodiment is for the pressurization system 52 to employ diffusers in the pressurant storage bottles 54 and 56 and/or in the propellant tanks 58 and 60.

The single building block for a distributed pressurization system 22 is designed with more valves than necessary in order to provide opportunities to isolate failures.

When multiple of these building blocks are employed to produce a distributed pressurization system, the present invention has higher levels of redundancy than prior art systems, allowing it to provide the required levels of pressurant to the propellant tanks and elsewhere as needed even with the failure of multiple valves. Another embodiment is hence for the pressurization system 52 is to employ software to control the valves 45 and 46 in such a fashion as to isolate system failures and provide fault tolerance.

Yet another embodiment is for the pressurization system 52 to use Tridyne, a common, commercially available pressurant mix of helium, hydrogen, and oxygen.

### III. Additional Features, Aspects & Applications of the Invention

### Low Cost

One important feature of the present invention is its low cost relative to comparable, prior art systems. Prior art pressurization systems are generally unique for each rocket design and use very expensive, aerospace components uniquely manufactured for this application. As most rockets are launched only a few times per year (and some only a few times per decade), production economies of scale for prior art pressurization systems are generally extremely small. Rather than exclusively employing very expensive, aerospace components uniquely manufactured for this application as with prior art systems, the present invention is carefully designed to allow use of very simple, very reliable, and relatively very low cost non-aerospace commercial-off-the-shelf (COTS) parts.

### Low Weight

An important feature of the present invention is its low weight compared to prior art systems. While some non-aerospace COTS components may be significantly heavier than their aerospace counterparts, the present invention's ability to recirculate and chill the pressurant prior to flight, placement of the pressurant storage bottles external to the propellant tanks, and ability to provide warmed pressurant to all of the pressurant storage bottles, results in an overall pressurization system weight significantly less than comparable, prior art systems. Similarly, the present invention requires a lower mass of pressurant than that for a prior art system providing the same pressurization.

### Enhanced Sustainability

Another important feature of the present invention is its greatly enhanced sustainability compared to prior art systems. By using commonly available, low cost, very reliable, non-aerospace COTS components, the present invention is far easier to sustain than prior art systems. Many of these non-aerospace COTS components are manufactured by multiple vendors to internationally specified standards and hence effectively are commodities; if one vendor exits the market, others exist that produce identical parts that may used without modification.

### Enhanced Reliability

Yet another important feature of the present invention is its greatly enhanced reliability compared to prior art systems. The present invention has higher levels of redundancy than prior art systems, allowing it to provide the required levels of pressurant to the propellant tanks and elsewhere as needed even with the failure of multiple valves. The single building block for a distributed pressurization system 22, for example, is designed with more valves than necessary in order to provide opportunities to isolate failures. When the present invention is applied to the case of segmented or otherwise mass producible launch systems, a large number of the single building blocks 22 are employed, providing additional opportunities to isolate failures and hence serving to increase the fault tolerance of the resultant distributed pressurization system 52.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Distributed Pressurization System that have been disclosed above are intended to educate the reader about preferred embodiments of the invention, and are not intended to constrain the limits of the invention or the scope of Claims.

### LIST OF REFERENCE CHARACTERS

10 Space launch vehicle, rocket, or missile

12 Fuel tank

14 Oxidizer tank

16 Rocket engine

18 Pressurant storage bottle

20 Control valve

22 Building block for a distributed pressurization system

24 Pressurant storage bottle

26 Pressurant line

28 High pressure inlet

30 High pressure outlet

32 Vent

33 First manifold

34 Second manifold

35 Third manifold

36 Propellant tank

38 Injector purge

40 Pneumatic control circuit

42 One-way flow valve

44 Pressure regulator

45 Three port control valve

46 Control valve

48 Mass flow regulator

50 Catalytic reactor

52 Distributed pressurization system

54 First pressurant storage bottle

56 Second pressurant storage bottle

58 Propellant tank

60 Propellant tank

64 Pressurant flow

What is claimed is:

1. A method pressurizing components of a rocket comprising the steps of:
providing a first pressurant storage bottle (54) and a second pressurant storage bottle (56);
said first and said second pressurant storage bottles (54 & 56) feeding a pressurant through a plurality of valves (45 & 46), a catalytic reactor (50), a pressurant line (26), a way flow valve (42), a mass flow regulator (48), and a plurality of manifolds (33, 34, and 35);
said pressurant being heated by passing said pressurant through said catalytic reactor (50);
providing a heated pressurant to a propellant tank (36) and to said second pressurant storage bottle (56) from said first pressurant storage bottle (54); and
providing said heated pressurant to a propellant tank (36) and to said first pressurant storage bottle (54) from said second pressurant storage bottle (56).

2. A method as recited in claim 1, in which:
said pressurant includes an inert gas and a non-explosive mixture of combustible gases that is catalytically heated by passing said pressurant through said catalytic reactor (50).

3. A method as recited in claim 2, in which:
said inert gas is helium.

4. A method as recited in claim 2, in which:
said inert gas is nitrogen.

5. A method as recited in claim 2, in which:
said non-explosive mixture of combustible gases includes hydrogen and oxygen.

6. A method as recited in claim 2, in which:
said non-explosive mixture of combustible gases includes methane and oxygen.

7. A method as recited in claim 2, in which:
said non-explosive mixture of combustible gases includes liquefied natural gas and oxygen.

8. A method as recited in claim 1, in which:
a desiccant is employed to remove water from the said heated pressurant.

9. A method as recited in claim 1, in which:
recirculating said pressurant while on the launch pad through said manifolds (33, 34, and 35), a high pressure inlet connection (28) and a high pressure outlet connection connections to an external ground system;
pumping and chilling said pressurant using said external ground system; and
increasing the density of the pressurant and the mass of said pressurant in said first pressurant storage bottle (54) and said second pressurant storage bottle (56).

10. A method as recited in claim 1, in which:
said pressurant is provided for a pneumatic control circuit (40).

11. A method as recited in claim 1, in which:
said pressurant is provided for a rocket engine injector purge (38).

12. A method as recited in claim 1, in which:
a diffuser inside the said first and said second pressurant storage bottles (54 & 56) is used to help mix said pressurant flowing into said first and said second pressurant storage bottles with said pressurant already residing in said first and said second pressurant bottles.

13. A method as recited in claim 1, in which:
a diffuser inside said propellant tank (36) is used to help mix said heated pressurant flowing into said propellant tank with said pressurant already residing in said tank.

14. A method as recited in claim 1, in which:
said catalytic reactors (50) use a heater to enhance the catalytic reaction.

15. A method as recited in claim 1, in which:
a vent (32) is used to expel any excess pressurant.

16. A method as recited in claim 1, in which:
the mass flow rate of said heated pressurant into said propellant tank (36) is regulated by means of a simple bang-bang control system that drives an array of control valves and venturi valves.
